(19) United States
(12) Patent Application Publication
(10) Pub. No.: US 2014/0068776 A1
(43) Pub. Date: Mar. 6, 2014

(54) USER INTERFACE HIJACKING PREVENTION DEVICE AND METHOD

(71) Applicant: Tencent Technology (Shenzhen) Company Limited, Shenzhen (CN)

(72) Inventors: Tian Ming XIAO, Shenzhen (CN); Yun Feng Dai, Shenzhen (CN)

(73) Assignee: Tencent Technology (Shenzhen) Company Limited, Shenzhen (CN)

(21) Appl. No.: 14/069,301

(22) Filed: Oct. 31, 2013

Related U.S. Application Data
(63) Continuation of application No. PCT/CN2013/082880, filed on Sep. 3, 2013.

(30) Foreign Application Priority Data
Sep. 5, 2012 (CN) 201210325491.8

(51) Int. Cl. G06F 21/56

(52) U.S. Cl. CPC G06F 21/561
USPC 726/24

(57) ABSTRACT

This discloses a device for preventing a user interface from being hijacked. The device can include: an information collecting module that collects information regarding a scheduled task; a monitoring module that monitors the scheduled task in accordance with the collected information to obtain a running status of the scheduled task and generates a control command in accordance with the running status; a user operation obtaining module that obtains a user operation after the monitoring module issues the control command; a window constructing module that constructs a window in accordance with the control command issued by the monitoring module and/or the user operation obtained by the user operation obtaining module; and a message generating module that generates a message and transmits the message to the window constructing module to display the message in the window. This also discloses a method of preventing a user interface from being hijacked.

### CROSS REFERENCE TO RELATED APPLICATION

This application is a U.S. continuation application filed under 35 U.S.C. §111(a) claiming priority under 35 U.S.C. §§120 and 365(c) to International Application No. PCT/CN2013/082880 filed Sep. 3, 2013, which claims the priority benefit of Chinese Patent Application No. 201210325491.8, filed on Sep. 5, 2012, the contents of both the PCT and Chinese applications are incorporated by reference herein in their entirety for all purposes.

### FIELD

This related to the anti-virus field, and in particular, to devices and methods for preventing a user interface from being hijacked.

### BACKGROUND

Currently, mobile internet is developing rapidly. The rise of the Android operating system also drives the development of applications suitable for mobile communication terminals. At the same time, computer viruses have gradually penetrated mobile communication terminals. These viruses can cause great destructions to the applications at the mobile communication terminals and, at the same time, become a great threat to the security of the mobile communication terminals.

The threats to the mobile communication devices caused by these viruses can include: unauthorized fee deductions, remote controlling, invasion of privacy, system sabotaging, user interface hijacking, etc. User interface hijacking can refer to: the virus causing a full-screen popup window to be displayed when activating device-admin rights or uninstallation software. The popup window can be laying on top of the interface for activating device-admin rights or uninstallation software. This popup window can be a fake interface with no input focus. The bottom portion of the interface can include a fake button image. This fake button image can be in the same location as the “activating” button on the device-admin rights activation interface and include language that has clear misleading tendency. When a user clicks on the fake button, because the fake interface does not receive an input focus, he actually activates the “activating” button on the activation interface, granting the virus device-admin rights. After obtaining the device-admin rights, the virus can execute certain operations requiring high-level device-admin rights, bringing severe threats to the mobile communication terminal.

To deal with the above-described interface-hijacking virus, currently, it involves scanning the static bytecode or binary code in its installation package to determine whether a related API (Application Programming Interface) has been called and prompting the user to uninstall the virus if a sensitive API call has been detected.

The biggest shortcoming of the above traditional virus-scanning method is that it is easy to make an incorrect determination. For example, some software requires device-admin rights to provide high-level operations such as screen-locking, restoring factory settings. But some device-admin software also provides uninstallation functions. If bytecode scanning is used, this regular software may also be blocked as a virus by the security software.

In another aspect, the above-described mechanism can only remove the risks when virus scanning is triggered. If the system environment is not examined in time, the necessary measure cannot be deployed in time when a virus hijacks an interface, eventually bringing severe threats to the user's mobile phone.

Thus, a new technical solution needs to be provided to resolve the above-described technical programs.

### SUMMARY

One of the objectives of the present disclosure is to provide a device for preventing a user interface from being hijacked. The device can accurately discover a user interface hijacking situation and deploy the necessary measures to prevent the user interface from being hijacked.

To solve the above-described problem, the disclosure can provide a user interface hijacking prevention device. The device can include: an information collecting module that collects information regarding a scheduled task; a monitoring module that monitors the scheduled task in accordance with the information collected by the information collecting module to obtain a running status of the scheduled task, and generates a control command in accordance with the running status of the scheduled task; a user operation obtaining module that obtains a user operation after the monitoring module issues the control command; a window constructing module that constructs a window in accordance with the control command issued by the monitoring module and/or the user operation obtained by the user operation obtaining module; and a message generating module that generates a message and transmits the message to the window constructing module to display the message in the window.

In the above-described user interface hijacking prevention device, the information collecting module can include: a start information collecting module that collects start information associated with the scheduled task; wherein the monitoring module monitors the scheduled task in accordance with the start information associated with the scheduled task collected by the start information collecting module to obtain the running status of the scheduled task, and transmits the control command when detecting the start of the scheduled task, the control command controlling the window constructing module's construction of the window.

In the above-described user interface hijacking prevention device, the information collecting module can also include an operation region recognition module that recognizes a corresponding operation region of the user interface at the start of the scheduled task and collects information associated with the operation region. The window constructing module can include: a first window constructing module that constructs a first window in accordance with the operation region when receiving the control command; and a second window constructing module that constructs a second window when the user operation obtaining module obtains the user operation. The first window can have a transparent or partially-transparent background. The first window can include a first operation region. The first window constructing module can also establish a link between the first operation region and the second window constructing module.

In the above-described user interface hijacking prevention device, the user operation obtaining module can obtain a first user operation after the first window constructing module constructs the first window. The first operation can include an operation in the first operation region. The first window constructing module can close the first window after the user operation obtaining module obtains the first user operation. The second window constructing module can construct a second window when the user operation obtaining module obtains the first user operation. The message generating module can generate a message and transmit the message to the second window. The second window can display the message.

In the above-described user interface hijacking prevention device, the user operation obtaining module can obtain a second user operation after the second window constructing module constructs the second window. The second window constructing module can close the second window after the user operation obtaining module obtains the second user operation.

Another goal of the present disclosure is to provide a user interface hijacking prevention method, which can, in real time, accurately determine that a user interface has been hijacked and deploy measures to prevent the user interface from being hijacked.

To solve the above-described problems, the present disclosure can provide a user interface hijacking prevention method. The method can include: collecting information regarding a scheduled task; monitoring the scheduled task in accordance with the collected information regarding the scheduled task to obtain a running status of the scheduled task, and generating a control command in accordance with the running status of the scheduled task; obtaining a user operation in accordance with the control command; constructing a window in accordance with the control command and/or the user operation; and displaying a message in the window.

In the above-described user interface hijacking prevention method, the method can also include: collecting start information associated with the scheduled task; monitoring the scheduled task in accordance with the start information associated with the scheduled task to obtain the running status of the scheduled task, transmitting the control command when detecting a start of the scheduled task, and constructing the window.

In the above-described user interface hijacking prevention method, the method can also include: recognizing a corresponding operation region of the user interface at the start of the scheduled task and collecting information associated with the operation region; when receiving the control command, constructing a first window in accordance with the operation region of the user interface, the first window having a transparent or semi-transparent background and including a first operation region, establishing a link between the first operation region and a second window constructing module; and constructing a second window when obtaining a user operation.

In the above-described user interface hijacking prevention method, the method can also include: obtaining a first user operation after constructing the first window, the first user operation being an operation on the first operation region, closing the first window, constructing the second window, generating and transmitting a message to the second window, and displaying the message in the second window.

In the above-described user interface hijacking presenting method, the method can also include: obtaining a second user operation and closing the second window.

In the embodiments of this disclosure, because the information collecting module is used for collecting information regarding a scheduled task, the monitoring module can monitor whether the scheduled task has started in accordance with this information. For example, it can monitor a security software uninstallation program to determine whether the security software uninstallation program has started. Accordingly, the user can be informed in real time if any unauthorized operation has occurred. Because viruses often call scheduled tasks (e.g., the security software uninstallation program) on an irregular basis, to prevent the user interface from being hijacked, it can be necessary to monitor, in real time, whether the scheduled task has started. In addition, when an unauthorized operation occurs, the virus can pop up a fake window to mislead the user when hijacking the user interface. The present disclosure can use a window-constructing module to construct a window and a user operation obtaining module to obtain a user operation. When the user is misled by the fake window into performing a related operation, the operation may temporarily be prevented from being carried out as a result of the mutual cooperation of the window constructing module and the user operation obtaining module. At the same time, the user can be informed of what actually happened. As a result, the present disclosure can facilitate anti-hijacking of a user interface (preventing the user interface from being hijacked) to prevent losses resulting from the user being misled by the virus.

To further explain the above-described content, exemplary embodiments are described below in view of the corresponding figures.

### BRIEF DESCRIPTION OF THE DRAWINGS

To better explain the technical solutions in the embodiments of the disclosure, the figures discussed in the following embodiments are briefly introduced. It should be understood that the figures described below correspond to only some of the embodiments and that other figures can be derived from these figures.

FIGS. 1A-1C illustrate a user interface hijacking prevention method, according to an embodiment of the disclosure.

FIG. 2 is a block diagram illustrating the exemplary modules of a user interface hijacking prevention device, according to an embodiment of the disclosure.

FIG. 3 is a block diagram illustrating the exemplary modules of the information collecting module 201 of the user interface hijacking prevention device of FIG. 2.

FIG. 4 is a block diagram of the exemplary modules of the window constructing module 204 of the user interface hijacking prevention device of FIG. 2.

FIGS. 5 and 6 are flow charts illustrating the exemplary steps of user interface hijacking prevention methods, according to embodiments of the disclosure.

FIG. 7 illustrates exemplary common components of a computing system such as the devices disclosed in the various embodiments below.

### DETAILED DESCRIPTION

A detailed description of the technical solutions of the embodiments of the present disclosure is provided below in view of the accompanying drawings. It should be understood that the embodiments described below are representative embodiments of the present disclosure rather than a complete disclosure of the every possible embodiment. The present disclosure can also include any other embodiments that can be derived from these disclosed embodiments by a person with ordinary skill in the art without any additional inventive work. It is to be understood that other embodiments can be used and structural changes can be made without departing from the scope of the embodiments of this disclosure.

In general, this relates to methods and devices for prevent a user interface from being hijacked by a virus. These methods and devices can be implemented on any types of computers or electronic devices running software programs. Such computer or device can include, but are not limited to, PCs, Macs, desktop computers, laptop computers, tablet PCs, smartphones including iPhones, Android phones, Windows phones, and Blackberries, e-readers, in-car communication devices, televisions, gaming consoles and other consumer electronic devices.

When a virus attempts to hijack a user interface of a device such as a user interface associated with high level device-admin operations or one for uninstall security software on the device, it can generate a fake popup user interface, such as an interface for claiming a price. The user may be misled into believe that the fake interface is an actual user interface and clicking on certain options displayed on the fake interface. This user action may be used by the virus to try to activate a real operation (e.g., an administrative operation or uninstalling the security software) on the actual user interface underneath the fake popup user interface. This can allow the virus to perform key operations without authorization or detection by the user and can result in serious breach of security on the device.

To prevent this from happening, embodiments of the disclosure can collect information relating to a particular schedule task such as uninstallation of security software and monitor the scheduled task in accordance with the collected information. When detecting a user operation (e.g., the user attempting to select an option on a fake popup user interface generated by the virus), a transparent or semi-transparent window can be constructed on top of the fake popup user interface so that the user can be blocked, at least temporarily, from unknowingly selecting an operation on the fake popup user interface. Another preferably opaque window can then be displayed to inform the user of the actual operation (e.g., uninstall the security software) he was about to select. As such, this can prevent the user from being misled by a fake popup generated by the virus into performing an operation that can cause security breach or other types of unintended consequences on the device.

Although the embodiments below disclose constructing one or more windows on top of the fake popup window, it should be understood that the user interface generated by the disclosed method or device can be any types of commonly known interface objects other than a window. It should also be understood that the scheduled tasks can be any task that can be performed on the device including, but not limited to, high-level administrative tasks and the uninstalling of security software or any other software on the device. A scheduled task can referred to any known task that can be performed by the device at any time. A user interface can include, but is not limited to, any known graphic user interfaces for computer, mobile devices or any other electronic devices running software. The user interface can be, for example, a touch-based user interface for receiving touch input or a user interface for receiving conventional keyboard and/or mouse input. An operation region of a user interface can be a particular region of that interface and be of any size, shape, color, and/or design. It can include buttons or other graphic items for activating one or more operations.

The various methods disclosed in the embodiments below can be implemented in software and programmed to run in the background when the device is in an operation mode susceptible to virus attacks. It can also be activated in response to detecting certain activities (e.g., a popup window being displayed).

Description of the following embodiments refers to the attached figures to illustrate the exemplary embodiments of the present disclosure.

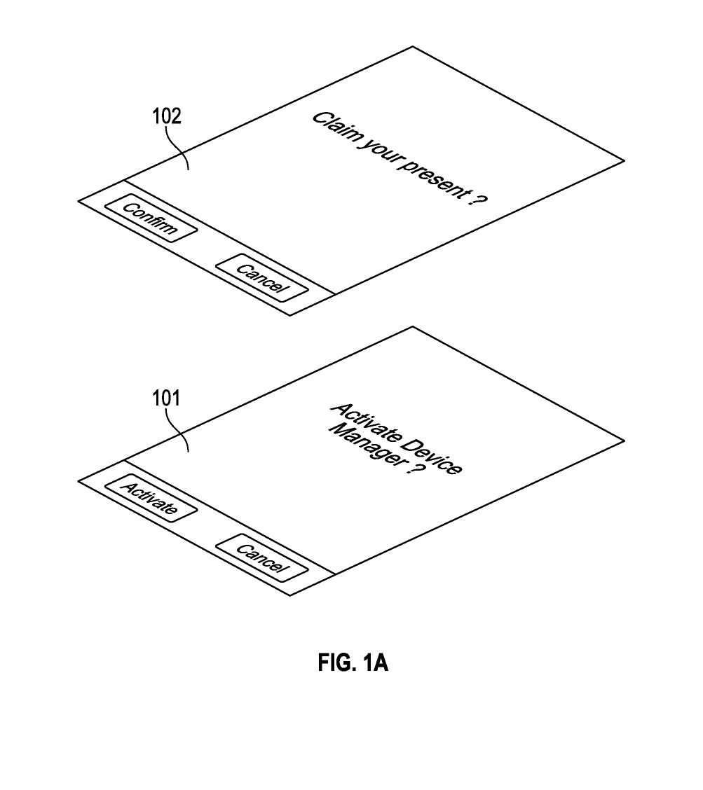

FIGS. 1A-1C illustrate a user interface hijacking prevention method, according to an embodiment of the disclosure. In FIG. 1A, a virus can generate a floating window 102 to hijack a user interface of a user device (the user interface can be a control interface for activating the device manager 101). It can be a deceptive way to mislead the user to click on the corresponding button in the floating window 102. In FIG. 1B, when detecting that a particular interface of the user device has being called up, the present embodiment can construct a first window 103. The first window 103 can include a first operation region 1031. The background of the first window 103 can be transparent or semi-transparent. When the user, being deceptively misled by the floating window 102, clicks on a button in the floating window 102, a corresponding button in the first operation region 1031 of the first window 103 can be the button actually clicked on. In FIG. 1C, the present embodiment can construct a second window 104 to inform the user regarding the actual situation (e.g., the user interface on the user device has been hijacked by the virus), and provide a second operation region 1041 to the user for carrying out a corresponding operation.

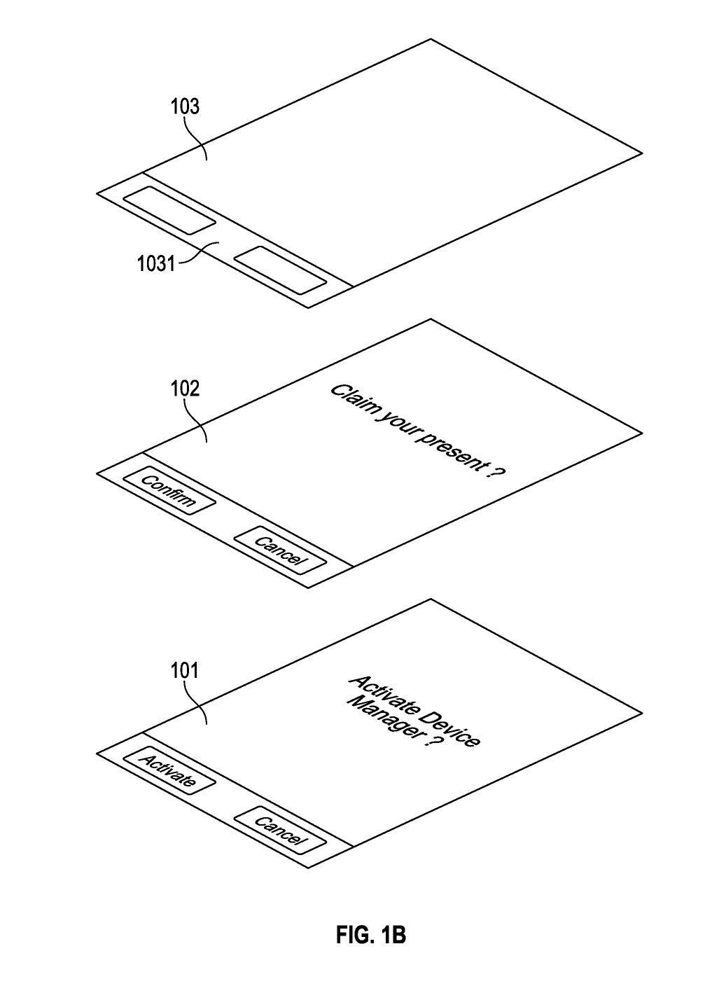

Referring to FIG. 2, FIG. 2 is a block diagram illustrating the exemplary modules of a user interface hijacking prevention device, according to an embodiment of the disclosure. The user interface hijacking prevention device can include an information collecting module 201, a monitoring module 202, a user operation obtaining module 203, a window constructing module 204, and a message generating module 205. The monitoring module 202 and the information collecting module 201 can be electrically connected. The user operation obtaining module 203 and the window constructing module 204 can be electrically connected. The window constructing module 204 and the information collecting module 201 can be electrically connected. The monitoring module 202, user operation obtaining module 203, and the message generating module 205 can be electrically connected.

The information collecting module 201 can collect information regarding a scheduled task. The scheduled task can be a scheduled process of a particular application program. For example, the scheduled task can be a security software uninstallation process or another process related to the administrative rights associated with the device. The collecting of the scheduled task by the information collecting module 201 can be beneficial to the comprehensive prevention of unauthorized activation of the related process by a virus. The monitoring module 202 can monitor the scheduled task in accordance with the information collected by the information collecting module 201 to obtain a running status of the scheduled task, and generate a control command in accordance with the running status of the scheduled task. The monitoring module 202 can also monitor whether an unauthorized user interface appears on top of a corresponding user interface at the start of the scheduled task. The monitoring of the scheduled task by the monitoring module 202 can be beneficial for detecting, in real time, whether the virus is starting the scheduled task without authorization. The user operation obtaining module 203 can obtain a user operation after the monitoring module issues the control command. The window constructing module 204 can construct a window in accordance with the control command issued by the monitoring module and/or the user operation obtained by the user operation obtaining module. The window constructed by the window constructing module 204 can be used as a medium for the user operation obtaining module 203 to obtain the user operation and for displaying a message to the user to make it possible to prevent the user interface from being hijacked and prevent the user from being misled. The message generating module 205 can generate a message and transmit the message to the window constructing module to be displayed in the window.

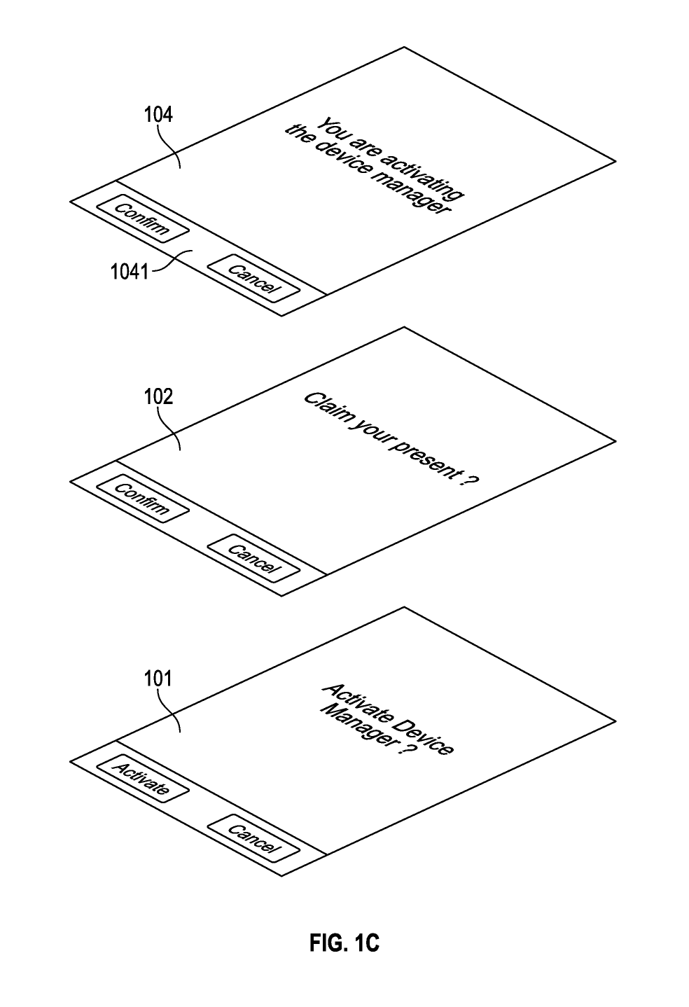

FIG. 3 is a block diagram illustrating the exemplary modules of the information collecting module 201 of the user interface hijacking prevention device of FIG. 2. The information collecting module 201 can include a start information collecting module 2011 and an operation region recognition module 2012. The start information collecting module 2011 can be electrically connected to the information collecting module 201 and the operation region recognition module 2012. The operation region recognition module 2012 can also be electrically connected to the window constructing module 204. The start information collecting module 2011 can collect start information associated with the schedule task. In particular, the staring information collecting module 2011 can collect the start information of the scheduled process of an application program. The scheduled process can be a software uninstallation process or a process relating to the administrative rights of the device. As such, the monitoring module 202 can monitor, using the start information of the scheduled task, whether the scheduled task has started, to effectively monitor the scheduled task in real time and, in turn, whether the virus has activated the scheduled task. This can get ready for preventing the virus from hijacking the user interface. The operation region recognition module 2012 can recognize a corresponding operation region of the user interface at the start of the scheduled task and collect information associated with the operation region. In particular, the operation region recognition module 2012 can collect the operation region information of the user interface corresponding to the scheduled process when the scheduled process of the application program is initiated. The operation region information can include one of or more of the size, shape, area, image content, text content, link information, etc. of the operation region. As such, the window constructing module 204 can construct a window based on the operation region information collected by the operation region recognition module 2012. The monitoring module 202 can monitor the scheduled task in accordance with the start information of the scheduled task collected by the start information collecting module 2011 to obtain the running status of the scheduled task, e.g., whether the scheduled task has started, and transmit the control command to the window constructing module 204 when the start of the scheduled task is monitored. The control command can control construction of the window by the window constructing module 204.

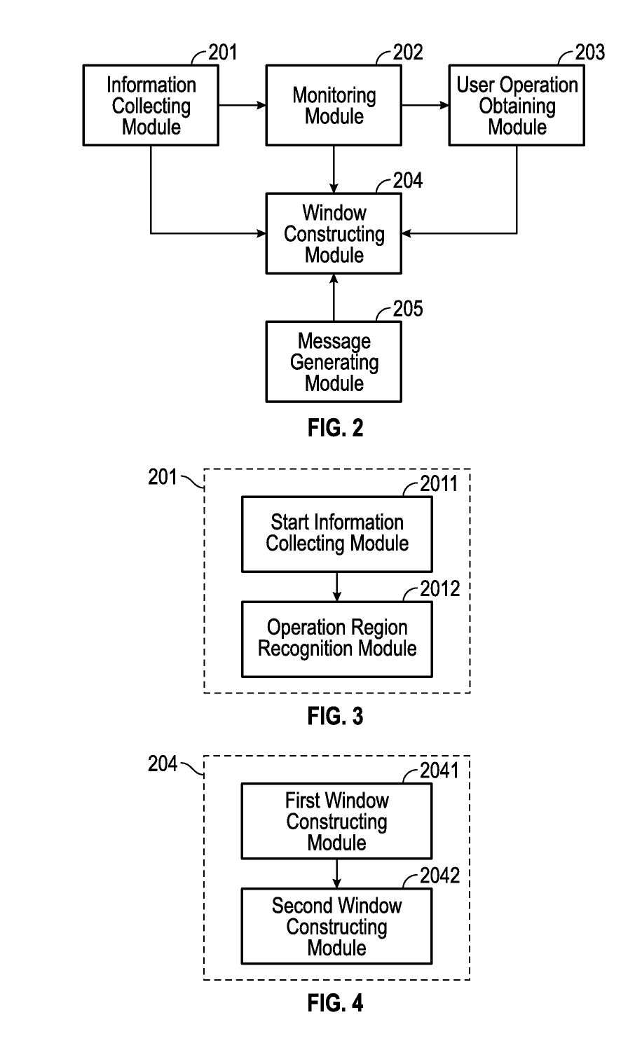

FIG. 4 is a block diagram of the exemplary modules of the window constructing module 204 of the user interface hijacking prevention device of FIG. 2. The window constructing module 204 can include a first window constructing module 2041 and a second window constructing module 2042. The first window constructing module 2041 can be electrically connected to the operation region recognition module 2012, the monitoring module 202, the user operation obtaining module 203, and the second window 104 constructing module 2042. The second window constructing module 2042 can be electrically connected to the user operation obtaining module 203 and the message generating module 205. The first window constructing module 2041 can construct a first window 103 based on the operation region information of the user interface at the start of the scheduled task when receiving the control command. The operation region information can be provided by the operation region recognition module 2012. The background of the first window 103 can be transparent of semi-transparent. That is, the first window 103 can be a transparent or semi-transparent window. The first window 103 can include a first operation region 1031. The shape, location, area and other information associated with the first operation region 1031 can be the same as that of the corresponding operation region of the user interface at the start of the scheduled task. The first operation region 1031 and the second window constructing module 2042 can be linked. The first window constructing module 2041 can establish the link between the first operation region 1031 and the second window constructing module 2042. As such, when the user operation has an effect on the first operation region 1031, the user interface hijacking prevention device of this embodiment can intercept the user operation via the first operation region 1031, so that the user operation is temporarily blocked from being executed. The user operation obtaining module 203 can obtain a first user operation after the first window constructing module 2041 constructs the first window 103. The first operation can include an operation in the first operation region 1031. That is, the first user operation can be an operation in the first operation region 1031. The first window constructing module 2041 can close the first window 103 after the user operation obtaining module 203 obtains the first user operation.

The second window constructing module 2042 can construct the second window 104 when the user operation obtaining module 203 obtains the user operation. In particular, the second window constructing module 2042 can construct the second window 104 when the user operation obtaining module 203 obtains the first user operation. The second window 104 can include a second operation region 1041. The second operation region 1041 can have an opaque background. The shape, location, area, image and other information associated with the second operation region 1041 can be the same as that of the corresponding operation region of the user interface at the start of the scheduled task. The message generating module 205 can generate a message and transmit the message to the second window constructing module 2042 so that the second window 104 can display the message. As such, the message can be displayed to alert the user when the user operation is temporarily blocked from being carried out to prevent the user from being misled by the virus.

As a further improvement, in the user interface hijacking prevention device of the present embodiment, the user operation obtaining module 203 can also obtain a second user operation after the second window construction module 2042 constructs the second window 104. The second window constructing module 2042 can also close the second window 104 after the user operation obtaining module 203 obtains the second user operation.

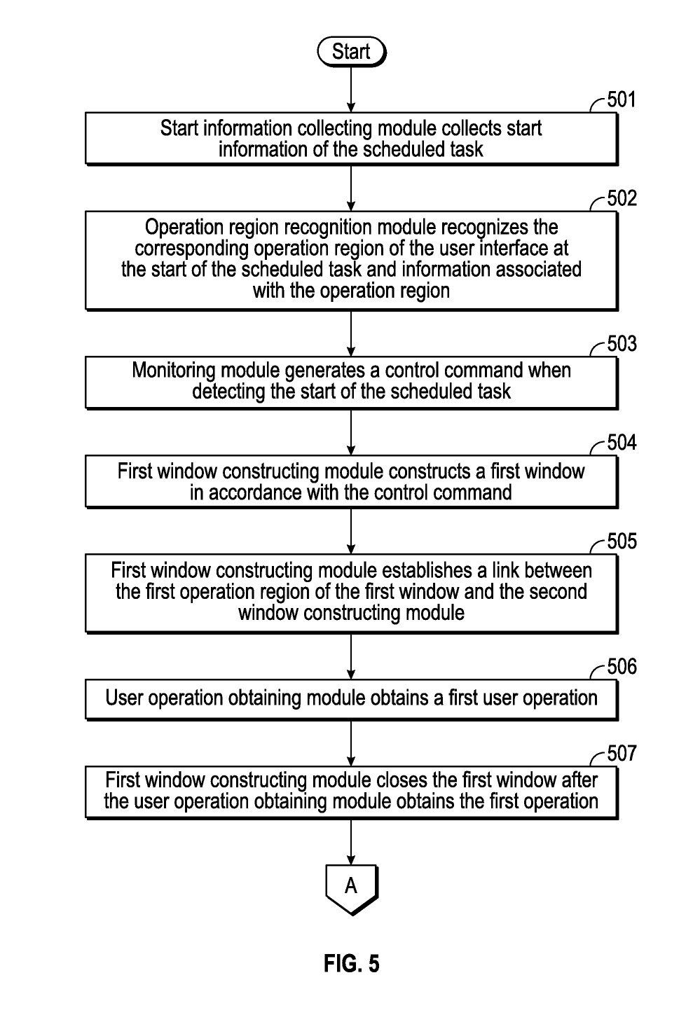

FIGS. 5 and 6 are flow charts illustrating the exemplary steps of user interface hijacking prevention methods, according to embodiments of the disclosure. The user interface hijacking prevention methods of the present disclosure can be carried out by a user interface hijacking prevention device. The user interface hijacking prevention device can include an information collecting module 201, monitoring module 202, user operation obtaining module 203, window constructing module 204, and message generating module 205. The information collecting module 201 can include a start information collecting module 2011 and an operation region recognition module 2012. The window constructing module 204 can include a first window constructing module 2041 and second window constructing module 2042.

In steps 501 and 502, the information collecting module 201 can collect information regarding a schedule task. In particular, in step 501, the start information collecting module 2011 can collect start information of the scheduled task. The scheduled task can be a scheduled process of an application program. For example, the scheduled process can be a security software uninstallation process or a process related to the device-admin rights. In step 502, the operation region recognition module 2012 can recognize the corresponding operation region of the user interface at the start of the scheduled task and information associated with the operation region. In particular, the operation region recognition module 2012 can collect the operation region information of the user interface corresponding to the scheduled process at the start of the scheduled task. The operation region information can include one or more types of information including the size, shape, area, image content, text content, link information of the operation region.

In step 503, the monitoring module 202 can monitor the scheduled task in accordance with the start information of the scheduled task collected by the start information collecting module 2011, i.e., to monitor whether the scheduled task has started, and transmit the control command to the window constructing module 204 when detecting that the scheduled task has started. The control command can control the window constructing module 204's construction of the window. The monitoring module 202 can also monitor whether an unauthorized user interface appears on top of the user interface corresponding to the scheduled task when the scheduled task starts.

In step 504, the window constructing module 204 can construct a window in accordance with the control command transmitted from the monitoring module 202. In particular, the first window constructing module 2041 can construct a first window 103 in accordance with the operation region information of the user interface when receiving the control command. The background of the first window 103 can be transparent or semi-transparent. The first window 103 can include a first operation region 1031. The shape, location, area and other information associated with the first operation region 1031 can be the same as that of the operation region of the user interface at the start of the scheduled task.

In step 505, the first window constructing module 2041 can establish a link between the first operation region 1031 and the second window constructing module 2042. That is, the first operation region 1031 can be the trigger for constructing the second window 104.

In step 506, the user operation obtaining module 203 can obtain a user operation after the monitoring module 202 transmits the control command. In particular, the user operating module 203 can obtain a first user operation after the first window constructing module 2041 constructs the first window 103. The first user operation can be an operation in the first operation region 1031. That is, the first user operation can be an operation directed to the first region.

In step 507, the first window constructing module 2041 can close the first window 103 after the user operation obtaining module 203 obtains the first operation.

In step 508, the window constructing module 204 can construct a window in accordance with the user operation obtained by the user operation obtaining module 203. In particular, the second window constructing module 2042 can construct a second window 104 when the user operation obtaining module 203 obtains the first operation. The second window 104 can include a second operation region 1041. The second operation region can have an opaque background. The shape, location, area, graphic and other information associated with the second operation region 1041 can be the same as that of the operation region of the user interface at the start of the scheduled task.

In step 509, the message generating module 205 can generate a message and transmit the message to the window constructing module 204 to be displayed in the window.

In step 510, the second window 104 can display the message.

As a further improvement, the user interface hijacking prevention method of the present disclosure can also include steps 511 and 512. In particular, in step 511, the user operation obtaining module 203 can obtain a second user operation after the second window constructing module 2042 constructs the second window 104. In step 512, the second window constructing module 2042 can close the second window 104 after the user operation obtaining module 203 obtains the second operation.

In the present disclosure, by using the information collecting module 201 to collect information associated with the scheduled task, the monitoring module 202 can determine whether the scheduled task has started in accordance with the information monitoring, e.g., monitoring a security software uninstallation program to determine whether the security software uninstallation program has started. This way, whether any unauthorized operation has been carried out can be detected in real time. Because a virus often randomly calls up a scheduled task (e.g., a security software uninstallation program), to prevent a user interface from being hijacked, it's necessary to monitor whether the schedule task has started. In addition, when an unauthorized operation occurs, because the virus can pop up a fake window to mislead the user when hijacking the user interface, the present disclosure can use a window constructing module 204 to construct a window and use the user operation obtaining module 203 to obtain a user operation. When the user performs a related operation as a result of being misled by the fake window, the user operation can be blocked temporarily from being carried out, with mutual cooperation between the window constructing module 204 and the user operation obtaining module 203, and the user can be informed of the actual situation. As such, the disclosure can facilitate anti-hijacking of a user interface (preventing a user interface from being hijacked), thereby preventing losses caused by the user being misled by the virus.

In some embodiments, one or more of the modules in FIGS. 2-4 can be stored and/or transported within any non-transitory computer-readable storage medium for use by or in connection with an instruction execution system, device, or device, such as a computer-based system, processor-containing system, or other system that can fetch the instructions from the instruction execution system, device, or device and execute the instructions. In the context of this file, a “non-transitory computer-readable storage medium” can be any medium that can contain or store the program for use by or in connection with the instruction execution system, device, or device. The non-transitory computer readable storage medium can include, but is not limited to, an electronic, magnetic, optical, electromagnetic, infrared, or semiconductor system, device or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

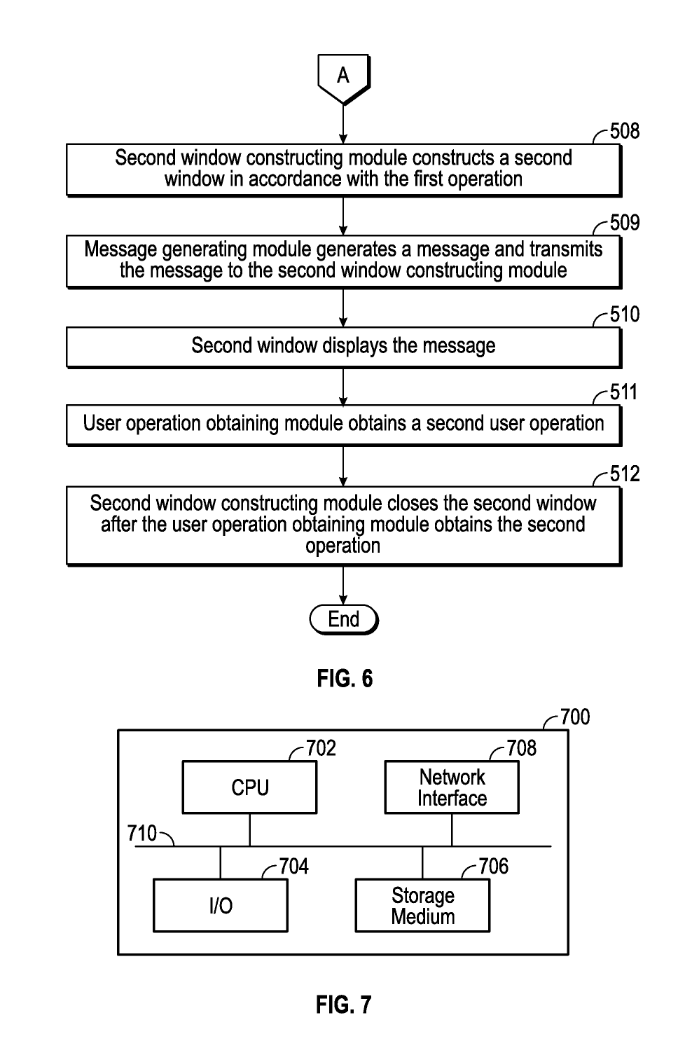

The non-transitory computer readable storage medium can be part of a computing system serving as the terminal or device of the above-described embodiments of the disclosure. FIG. 7 illustrates exemplary common components of one such computing system. As illustrated, the system 700 can include a central processing unit (CPU) 702, I/O components 704 including, but not limited to one or more of display, keypad, touch screen, speaker, and microphone, storage medium 706 such as the ones listed in the last paragraph, and network interface 708, all of which can be connected to each other via a system bus 710. The storage medium 706 can include the modules/units of FIGS. 2-4.

The above description presents only a relatively preferred embodiment of the present invention, and does not mean to restrict this invention. Any modification, equivalent replacement, improvement made on the basis of the spirit and principle of the present invention shall be included in the scope of protection for the present invention.

What is claimed is:

1. A user interface hijacking prevention device, comprises:
an information collecting module that collects information regarding a scheduled task,
a monitoring module that monitors the scheduled task in accordance with the information collected by the information collecting module to obtain a running status of the scheduled task, and generates a control command in accordance with the running status of the scheduled task,
a user operation obtaining module that obtains a user operation after the monitoring module issues the control command,
a window constructing module that constructs a window in accordance with the control command issued by the monitoring module and/or the user operation obtained by the user operation obtaining module, and
a message generating module that generates a message and transmits the message to the window constructing module to display the message in the window.

2. The device of claim 1, wherein the information collecting module comprises:
a start information collecting module that collects start information of the scheduled task,
wherein the monitoring module monitors the scheduled task in accordance with the start information of the scheduled task collected by the start information collecting module to obtain the running status of the scheduled task, and transmits the control command when detecting a start of the scheduled task, the control command controlling the window constructing module's construction of the window.

3. The device of claim 2, wherein the information collecting module comprises:
an operation region recognition module that recognizes an operation region of the user interface corresponding to the start of the scheduled task and collects information associated with the operation region,
wherein the window constructing module comprises
a first window constructing module that constructs a first window based on the operation region when receiving the control command, and
a second window constructing module that constructs a second window when the user operation obtaining module obtains the user operation,
wherein the first window comprises a transparent or partially-transparent background, the first window comprising a first operation region, the first window constructing module also establishes a link between the first operation region and the second window constructing module.

4. The device of claim 3, wherein,
the user operation obtaining module obtains a first user operation after the first window constructing module constructs a first window, the first operation comprising an operation in the first operation region,
the first window constructing module closes the first window after the user operation obtaining module obtains the first user operation,
the second window constructing module constructs a second window when the user operation obtaining module obtains the first user operation, and
the message generating module generates the message and transmits the message to the second window, the second window displaying the message.

5. The device of claim 4, wherein the user operation obtaining module obtains a second user operation after the second window constructing module constructs the second window, and
the second window constructing module closes the second window after the user operation obtaining module obtains the second user operation.

6. A user interface hijacking prevention method, comprising:
collecting information regarding a scheduled task,
monitoring the scheduled task in accordance with the collected information regarding the scheduled task to obtain a running status of the scheduled task, and generating a control command in accordance with the running status of the scheduled task,
obtaining a user operation in accordance with the control command,
constructing a window in accordance with the control command and/or the user operation, and
displaying a message in the window.

7. The method of claim 6, wherein the method comprising:
collecting start information associated with the scheduled task,
monitoring the scheduled task in accordance with the start information associated with the scheduled task to obtain the running status of the scheduled task,
transmitting the control command when detecting a start of the scheduled task, and
constructing the window.

8. The method of claim 7, comprising:
recognizing an operation region of the user interface corresponding to the start of the scheduled task and collecting information associated with the operation region,
when receiving the control command, constructing a first window in accordance with the operation region of the user interface, the first window having a transparent or semi-transparent background, the first window comprising a first operation region,
establishing an association between the first operation region and a second window, and
constructing a second window when obtaining the user operation.

9. The method of claim 8, comprising:
obtaining a first user operation after constructing the first window, the first user operation being an operation for the first operation region, closing the first window, constructing the second window, generating and transmitting a message to the second window, and displaying the message in the second window.

10. The method of claim 9, comprising:
obtaining a second user operation, and closing the second window.

11. A non-transitory computer-readable medium of a device, the medium storing a program which, when executed by a processor, performs the steps of:
collecting information regarding a scheduled task,
monitoring the scheduled task in accordance with the collected information regarding the scheduled task to obtain a running status of the scheduled task, and generating a control command in accordance with the running status of the scheduled task,
obtaining a user operation in accordance with the control command,
constructing a window in accordance with the control command and/or the user operation, and
displaying a message in the window.

12. The non-transitory computer-readable medium of claim 11, wherein the program which, when executed by a processor, performs the steps of:
collecting start information associated with the scheduled task,
monitoring the scheduled task in accordance with the start information associated with the scheduled task to obtain the running status of the scheduled task,
transmitting the control command when detecting a start of the scheduled task, and
constructing the window.

13. The non-transitory computer-readable medium of claim 12, wherein the program which, when executed by a processor, performs the steps of:
recognizing an operation region of the user interface corresponding to the start of the scheduled task and collecting information associated with the operation region,
when receiving the control command, constructing a first window in accordance with the operation region of the user interface, the first window having a transparent or semi-transparent background, the first window comprising a first operation region,
establishing an association between the first operation region and a second window, and
constructing a second window when obtaining the user operation.

14. A device comprising:
a processor,
a display, and
a memory unit that stores a program which, when executed by the processor, performs the steps of:
displaying a task-activating user interface on the display for activating a task,
detecting a popup window being displayed on top of the task-activating user interface, the popup window soliciting a user operation to activate the task,
displaying a first window at least partially corresponding to the popup window on top of the popup window,
receiving a user operation to activate the task after the first window is displayed,
blocking the task from being performed, and
displaying a message confirming that the task is to be performed while task is blocked from being performed.

15. The device of claim 14, wherein the first window comprises a transparent or partially transparent background.

16. The device of claim 14, wherein the program which, when executed by the processor, perform the step of displaying a second window for displaying the message.

17. The device of claim 14, wherein the task comprises a task concerning device-admin rights or a software uninstallation task.

18. The device of claim 17, wherein the software uninstallation task is for uninstalling security software.

19. The device of claim 14, wherein the popup window substantially overlaps the task-activating user interface.

20. The device of claim 14, wherein the user operation comprises selecting an option displayed in the popup window.
